(19) United States
(12) Patent Application Publication
(10) Pub. No.: US 2018/0277805 A1
(43) Pub. Date: Sep. 27, 2018

(54) CASE AND BATTERY ASSEMBLY OF ELECTRONIC CIGARETTE, AND ELECTRONIC CIGARETTE

(71) Applicant: SHENZHEN IVPS TECHNOLOGY CO., LTD., Shenzhen (CN)

(72) Inventor: Wen CHEN, Shenzhen (CN)

(73) Assignee: SHENZHEN IVPS TECHNOLOGY CO., LTD., Shenzhen (CN)

(21) Appl. No.: 15/935,148

(22) Filed: Mar. 26, 2018

(30) Foreign Application Priority Data
Mar. 27, 2017 (CN) 201720306752.X

(51) Int. Cl. H01M 2/10; A24F 47/00

(52) U.S. Cl. CPC H01M 2/1055; H01M 2220/30; A24F 47/008

(57) ABSTRACT

The present disclosure relates to a case, a battery assembly and an electronic cigarette having the case. The case includes a main body, a cover, and an elastic assembly. The cover is pivotally mounted to the main body. One end of the cover adjacent to the main body defines a groove. The elastic assembly is located at the main body; the elastic assembly has a top portion being in alignment with the groove. The top portion is configured for supporting on a certain portion of the cover when the cover is rotated.

### CROSS REFERENCE TO RELATED APPLICATIONS

The present application claims the priority of Chinese Patent Application No. 201720306752.X filed on Mar. 27, 2017, the contents of which is hereby incorporated by reference.

### TECHNICAL FIELD

The present disclosure relates to electronic cigarettes, in particular to a case, and a battery assembly and an electronic cigarette having the case.

### BACKGROUND

Electronic cigarettes are also known as virtual cigarettes, or E-atomizers. The electronic cigarette is a heat-not-burn product. The electronic cigarette is provided with efficacies similar to those of the ordinary cigarette. Electronic cigarette can refresh the smokers and satisfy their smoking addiction, making them happy and relaxed. Nowadays, the electronic cigarette has a battery detachably received in a case body, and a cover detachably mounted to the case for covering the battery. In detail, one side of the cover is pivoted to the case body, and the other side is fastened to the case body. However, the cover can't be retained in a certain position and will wobble easily while the case body is released.

Therefore, there is room for improvement in the art.

### SUMMARY

The present disclosure relates to a case, a battery assembly and an electronic cigarette having the case. The case includes a main body, a cover, and an elastic assembly. The cover is pivotally mounted to the main body. One end of the cover adjacent to the main body defines a groove. The elastic assembly is located at the main body; the elastic assembly has a top portion being in alignment with the groove. The top portion is configured for supporting on a certain portion of the cover when the cover is rotated.

### BRIEF DESCRIPTION OF THE DRAWINGS

For a better understanding of the embodiments of the present disclosure or the technical scheme in the prior art, accompanying drawings needed in the description of the embodiments or the prior art are simply illustrated below. Obviously, the accompanying drawings described below are some embodiments of the present disclosure. For the ordinary skill in the field, other accompanying drawings may be obtained according to the structure shown in these accompanying drawings without creative work.

FIG. 1 is an exploded perspective view of a case in accordance to an embodiment.

FIG. 2 is a cross-sectional view of a case when having been assembled in accordance to an embodiment.

FIG. 3 is an exploded perspective view of a bottom of the case in accordance to an embodiment.

FIG. 4 is a cross-sectional view of an elastic assembly in accordance to an embodiment.

### DETAILED DESCRIPTION OF THE EMBODIMENTS

A clear and complete description as below is provided for the technical scheme in the embodiments of the present disclosure in conjunction with the drawings in the embodiments of the present disclosure. Obviously, the embodiments described hereinafter are simply part embodiments of the present disclosure, but all the embodiments. All other embodiments obtained by the ordinary skill in the art based on the embodiments in the present disclosure without creative work are intended to be included in the scope of protection of the present disclosure.

It should be noted that all directional indications (such as top, bottom, left, right, front, behind . . . ) in the embodiments of the present disclosure are merely to illustrate a relative position relation, a relative motion condition, etc. between each part in a certain state (for example, the state shown in the drawings). If the state changes, the directional indication changes accordingly.

In addition, if terms “first”, “second”, etc. appear in the present disclosure, they are merely for the purpose of description, but cannot be understood as the indication or implication of relative importance or as the implicit indication of the number of the designated technical features; therefore, features defined by “first” and “second” may specifically or implicitly include one or more such features. In the description of the present disclosure, unless otherwise stated, “a plurality of” means at least two, for example, two, three, etc.

In the present disclosure, unless otherwise specifically stated and defined, terms “connected”, “fixed”, etc. should be interpreted expansively. For example, “fixed” may be fixed connection, also may be detachable connection, or integration; may be mechanical connection, also may be electrical connection; may be direct connection, also may be indirect connection through an intermediate, and may be internal communication between two elements or interaction of two elements, unless otherwise specifically defined. The ordinary skill in this field can understand the specific implication of the above terms in the present disclosure according to specific conditions.

In addition, technical schemes of each embodiment of the present disclosure maybe combined mutually; however, this must be carried out on the basis that the or ordinary skill in this field can implement the combination. When the combination of technical schemes has a conflict or cannot be implemented, it should considered that such combination of technical schemes does not exist and is not in the scope of protection claimed by the present disclosure.

The present disclosure relates to a case for a battery assembly and an electronic cigarette, aiming to solve the problem of wobble in structure in related art.

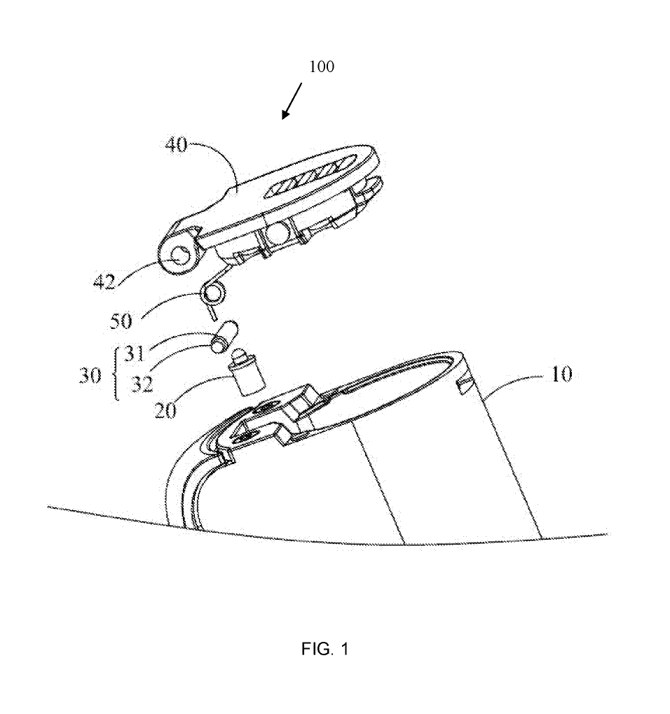

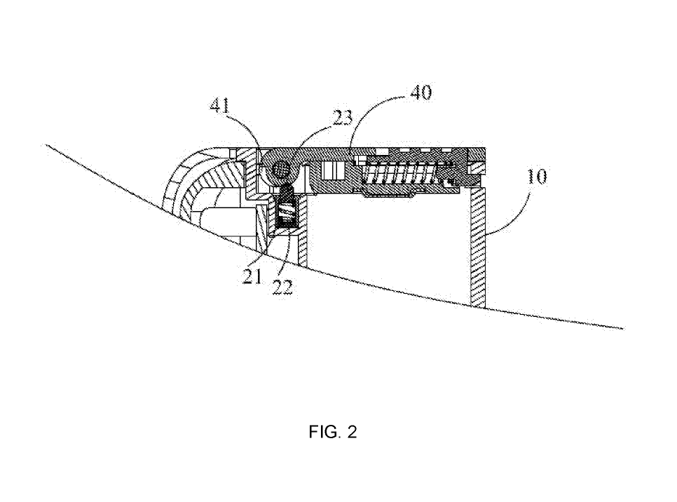

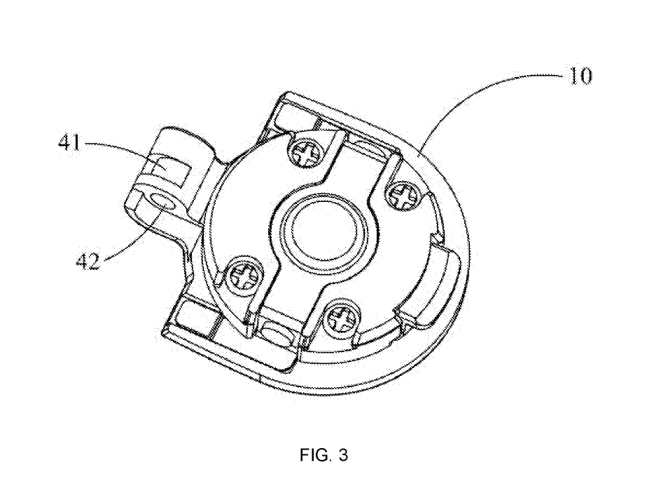

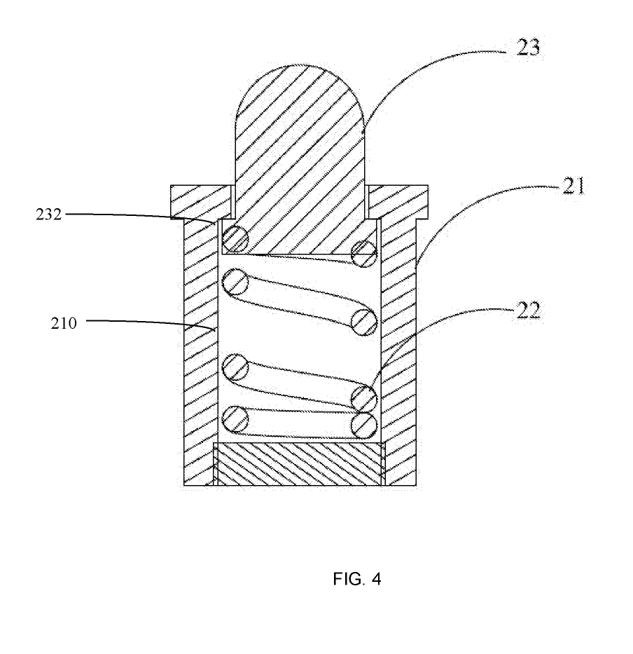

Referring to FIGS. 1-4, in one exemplary embodiment, a case 100 includes a main body 10, an elastic assembly 20 fixed on the main body 10, a cover 40 pivoted to the main body 10 via a pivot 30.

An end of the cover 40 pivoted to the main body 10 defines a groove 41. The elastic assembly 20 is arranged in alignment with the groove 41, and the elastic assembly 20 is inserted into the groove 41 and supports the cover 40 in a certain position when the cover 40 is opened. The elastic assembly 20 is stretchable. The other end of the cover 40, away from the end pivoted to the main body 10, is fastened to the main body 10 via a fasten mechanism (not labeled). When the end of the cover 40 fastened to the main body 10 is released, the cover 40 can rotate with respective with the pivot 30, the top portion of the elastic assembly 20 is inserted into the groove 41 and supports on the certain position of the cover 40. It is to be understood that, during rotation of the cover 30, the elastic assembly 20 abuts against the certain position of the cover 40 corresponding to the groove 41 and the elastic assembly 20 is stretched to pull on the cover 40, and the cover 40 is thus prevented from wobbling and generating noise.

The elastic assembly 20 includes a housing 21, an elastic element 22 and an elastic rod 23 located into a receiving room 210 formed in the housing 21. The elastic element 22 is fixed in the housing 21. The elastic element 22 may be, for example, a spring, or an elastic strip, an elastic gasket. The elastic rod 23 is secured on the elastic elements 22. The elastic rod 22 has a top portion 220 protruding out of the top of housing 21 from an opening 212 to support on the certain position corresponding to the groove 41. The opening 212 is defined in the housing 21 and communicates with the receiving room 210. It is to be understood that, during the rotation of the cover 40, the elastic rod 23 is pressed to deform by the cover 40, and generates an elastic force exerted to the cover 40, so that the cover 40 is stabilized opened. Further, a blocking member 232 is located on the elastic rod 22, the blocking member 232 is configured to prevent the elastic rod 22 from dropping off from the housing 21. The blocking member 232 may be, for example, a ring board or a square board or a rectangle board. If desired, the blocking member 232 is integrally formed in the elastic rod 23 to simplify the elastic assembly 20 structure, and be easily assembled. Furthermore, the top portion 220 may have a spherical surface to make the cover 40 rotate smoothly. The elastic rod 23 may be but not limited to a rubber.

The main body 10 is concaved to form a recess (not labeled), a sidewalls (not labeled) of the recess, and two opposite pivot holes (not labeled) on the sidewall for communicating with the recess. The cover 40 extends a protrusion (not labeled) in accordance with the recess. The protrusion defines a rotating hole 42 through the protrusion and allowing the pivot 30 to pass through. The pivot 30 includes a base portion 31, and two limiting portions 32 respectively placed at two opposite sides of the base portion 31. The limiting portions 32 can be elastically deformed. The elastic assembly 20 further includes a torsion spring 50 sleeved on the pivot 30.

When assembled, first, the pivot 30 and the torsion spring 50 are assembled to the cover 40, in detail, the pivot 30 is inserted into the rotating hole 42 and then the torsion spring 50 is sleeved on the pivot 30, that the base portion 31 is placed in the rotating hole 42, and the two limiting portions 32 expose out of the protrusion. Second, the cover 40 together with the pivot 30 and torsion spring 50 are assembled to the main body 10. In detail, the cover 40 together with the pivot 30 and torsion spring 50 are positioned above the main body 10 that the protrusion is in alignment with the recess, and then the cover 40 is moved to the main body 10 gradually to make the protrusion gradually insert into the recess and the limiting portions 32 are pressed to deform. When the limiting portions 32 move to the rotating hole 42, the limiting portions 32 are correspondingly extended into the pivot holes to mount the cover 40 to the main body 10. And one end of torsion spring 50 is perpendicularly contacted to the sidewall of the recess; the other end of the torsion spring 50 is parallel contacted to the sidewall of the groove 41. Third, the elastic assembly 40 is placed into the main body 10 with the top portion 220 extending out of the main body 10 to be in alignment with the groove 41. Thus, the assembly of the case 100 is finished.

When the cover 40 is closed, the cover 40 is rotated to enable the end of the cover 40 away from the pivot 30 to close on the main body 10 via the fasten mechanism. At this time, the torsion spring 50 deforms because of twisting. It is to be understood that nearer the cover 40 is rotated to the main body 10, the stronger force is exerted to the cover 40 by the torsion spring 50.

When the cover 40 is opened, the cover 40 is released from the main body 10, the cover 40 is stably and rapidly rotated to a desired position because of elastic assembly 20. In detail, the torsion spring 50 enables the cover 40 to rotate rapidly, the elastic element 22 and elastic rod 23 enables the cover 40 to retain stabilization.

The present disclosure also provides a battery assembly (not shown), the battery assembly includes the case 100 described above and a battery received in the case 100. Furthermore, the present disclosure also provides an electronic cigarette (not shown). The electronic cigarette includes the case 100 described above and an atomizer coupled to the case 100 described above. Accordingly, the cover 40 of the battery assembly or the electronic cigarette can be retained stabilization.

The above are preferred embodiments of the present disclosure merely and are not intended to limit the patent scope of the present disclosure. Any equivalent structures made according to the description and the accompanying drawings of the present disclosure without departing from the idea of the present disclosure, or any equivalent structures applied in other relevant technical fields directly or indirectly are intended to be included in the patent protection scope of the present disclosure.

What is claimed is:

1. A case, comprising:
a main body;
a cover rotatably mounted to the main body, one end of the cover adjacent to the main body defining a groove; and
an elastic assembly received in the main body, the elastic assembly having a top portion corresponding to the groove, and the top portion being configured to insert into the groove to elastically abuts a certain portion of the cover when the cover is rotated.

2. The case according to claim 1, wherein the elastic assembly comprises:
a housing; and
an elastic rod fixed in the housing, the elastic rod being provided with the top portion, the top portion extending out of the housing.

3. The case according to claim 2, wherein the elastic assembly further comprises an elastic element received in the housing, the elastic rod is secured to the elastic element.

4. The case according to claim 3, wherein the elastic assembly further comprises a blocking member at an end of the elastic rod adjacent to the elastic member, the blocking member is configured to limit the elastic rod within the housing.

5. The case according to claim 1, wherein the elastic rod and the blocking member are integrally molded.

6. The case according to claim 1, wherein the top portion has a spherical surface.

7. The case according to claim 1, wherein the other end of the cover is selectively fastened to the main body or released from the main body.

8. A battery assembly, comprising:
a battery, and
a case configured for receiving the battery, the case comprising:
a main body;
a cover pivoted to the main body, one end of the cover adjacent to the main body defining a groove; and
an elastic assembly received in the main body, the elastic assembly having a top portion inserted in to the groove to exert an elastic force to the cover when the cover is rotated.

9. The battery assembly according to claim 8, wherein the elastic assembly comprises:
a housing; and
an elastic rod fixed in the housing, the elastic rod being provided with the top portion, the top portion extending out of the housing.

10. The battery assembly according to claim 9, wherein the elastic assembly further comprises an elastic element received in the housing, the elastic rod is secured to the elastic element.

11. The battery assembly according to claim 10, wherein the elastic assembly further comprises a blocking member at an end of the elastic rod adjacent to the elastic member, the elastic rod is configured to limit the elastic rod within the housing.

12. The battery assembly according to claim 11, wherein the elastic rod and the blocking member are integrated molded.

13. The battery assembly according to claim 8, wherein the top portion of the elastic rod has a spherical surface.

14. The battery assembly according to claim 8, wherein the other end of the cover is selectively fastened to the main body or released from the main body.

15. An electronic cigarette, comprising:
a case, comprising:
a main body;
a cover pivotally mounted to the main body, one end of the cover adjacent to the main body defining a groove; and
an elastic assembly located at the main body, the elastic assembly having a top portion being in alignment with the groove, and the top portion being configured for elastically supporting on a certain portion of the cover when the cover is rotated; and
an atomizer coupled to the case.

16. The electronic cigarette according to claim 15, wherein the elastic assembly comprises:
a housing; and
an elastic rod fixed in the housing, the elastic rod being provided with the top portion, the top portion extending out of the housing.

17. The electronic cigarette according to claim 16, wherein the elastic assembly further comprises an elastic element received in the housing, the elastic rod is secured to the elastic element.

18. The electronic cigarette according to claim 17, wherein the elastic assembly further comprises a blocking member at an end of the elastic rod adjacent to the elastic member, the elastic rod is configured to limit the elastic rod within the housing.

19. The electronic cigarette according to claim 18, wherein the elastic rod and the blocking member are integrated molded.

20. The electronic cigarette according to claim 15, wherein the other end of the cover is selectively fastened to the main body or released from the main body.
